(19) United States
(12) Patent Application Publication
(10) Pub. No.: US 2011/0049813 A1
(43) Pub. Date: Mar. 3, 2011

(54) GASKET FOR EXHAUST PIPE OF VEHICLE

(75) Inventor: Hakson HAN, Seongnam-si (KR)

(73) Assignees: HYUNDAI MOTOR COMPANY, Seoul (KR); KIA MOTORS CORPORATION, Seoul (KR)

(21) Appl. No.: 12/619,220

(22) Filed: Nov. 16, 2009

(30) Foreign Application Priority Data
Sep. 3, 2009 (KR) 10-2009-0082919

(51) Int. Cl. F16L 17/06

(52) U.S. Cl. 277/608

(57) ABSTRACT

A gasket for an exhaust pipe of a vehicle which is formed by overlapping a plurality of plates having a center hole in common, may include the plate having, in the cross section thereof, a bead plane formed along a circumference of the center hole of the plate, a bead slope portion extending from the bead plane and bent against a bead slop portion of an adjacent plate, and a plate portion extending from the bead slope portion outward the center hole, wherein the bead plane overlaps the bead plane of the adjacent plate.

### CROSS-REFERENCE TO RELATED APPLICATIONS

The present application claims priority to Korean Patent Application Number 10-2009-0082919 filed Sep. 3, 2009, the entire contents of which application is incorporated herein for all purposes by this reference.

### BACKGROUND OF THE INVENTION

1. Field of the Invention

The present invention relates to a gasket for the exhaust pipe of vehicles, in detail, a technology about a gasket for the exhaust pipe of vehicles which is disposed between two flanges to maintain airtightness, in which the exhaust pipe is formed by jointing the flanges.

2. Description of Related Art

A jointing method using flanges 500 as shown in FIG. 1 is used in the related art, in which the combination is achieved by fastening force generated between stud bolts 502 and nuts 504, with flanges 500 facing each other, and a gasket 508 is interposed between flanges 500 to prevent leakage of exhaust gas passing through an exhaust pipe 506 and condensed water created in exhaust pipe 506.

FIG. 2 illustrates the gasket structure in the related art, as described above, in which foul folds of steel plate 510 overlap in a bent cross section, as shown in the cross-sectional view, such that they generate surface pressure to seal two flanges 500, when compression force is applied to two flanges 500 in jointing.

The steel plate type gasket 508, as described above, are widely used because sealing performance and thermal resistance are the most excellent in the related art; however, when relatively wide flanges are used or the rigidity of the flanges is low, the surface pressure is not uniformly distributed throughout gasket 508, such that gas or condensed water occasionally leaks from the joint of the flanges while vehicles practical travel.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

Various aspects of the present invention are directed to provide a gasket for the exhaust pipe of a vehicle that has high thermal resistance, generates uniform surface pressure between flanges, and makes it possible to improve sealing performance.

In an aspect of the present invention, the gasket for an exhaust pipe of a vehicle which is formed by overlapping a plurality of plates having a center hole in common, may include the plate having, in the cross section thereof, a bead plane formed along a circumference of the center hole of the plate, a bead slope portion extending from the bead plane and bent against a bead slop portion of an adjacent plate, and a plate portion extending from the bead slope portion outward the center hole, wherein the bead plane overlaps the bead plane of the adjacent plate.

The plate portion may be in parallel with the corresponding bead plane.

Two adjacent plates may have a symmetrical cross section from the portion where the bead planes of the two adjacent plates overlap.

The total number of portions where the bead planes forming the center hole, overlap each other may be half the total number of plate portions of the plates to form the gasket.

The plate may have connecting portions having a connecting hole at both sides of the plate from the center hole, and the length of the bead slope portion in the plate may be variable along the circumference of the center hole, wherein the closer the bead slope portion to the connecting hole of the connecting portion is, the larger the length of the bead slope portion from the center hole becomes, and the farther the bead slope portion from the connecting hole is, the smaller the length of the bead slope portion from the center hole becomes.

The length of the bead plane may be smaller than the length of the corresponding bead slope portion.

The length of the bead plane may be larger than the half of the length of the corresponding bead slope portion.

The plurality of plates may include even number of plates, and two adjacent plates may make a pair with the bead slope portions bending to face against each other, and the bead planes overlap.

In various aspects, the present invention provides a gasket for the exhaust pipe of a vehicle that may have high thermal resistance, generates uniform surface pressure between flanges, and makes it possible to improve sealing performance.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a view illustrating the joint structure of the exhaust pipe of a vehicle in the related art.

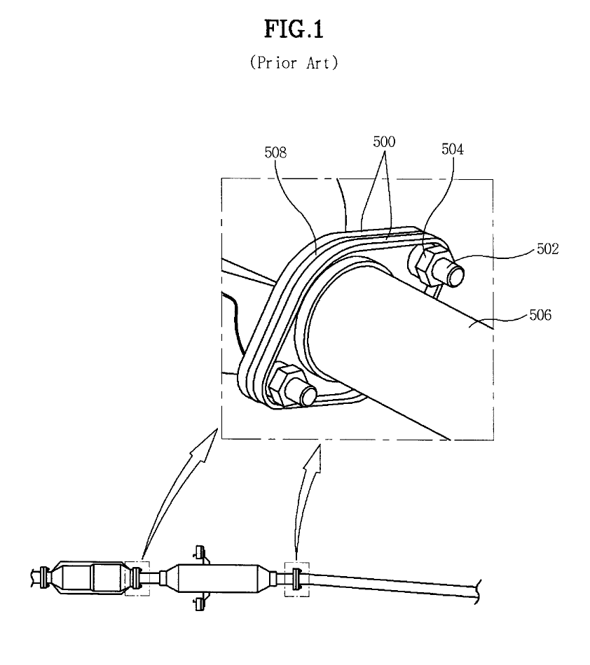

FIG. 2 is a view illustrating the structure of a gasket for the exhaust pipe of a vehicle according to the related art.

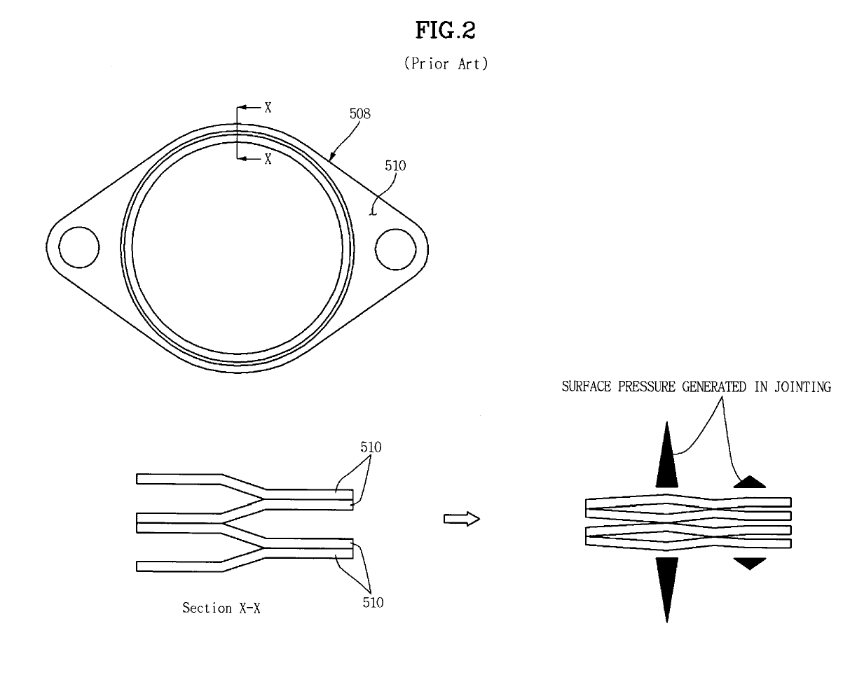

FIG. 3 is a view illustrating the structure of a gasket for the exhaust pipe of a vehicle according to an exemplary embodiment of the present invention.

FIG. 4 is a view of comparing effects of an exemplary embodiment of the present invention and the related art, by using an experiment using a pressure sensing paper.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

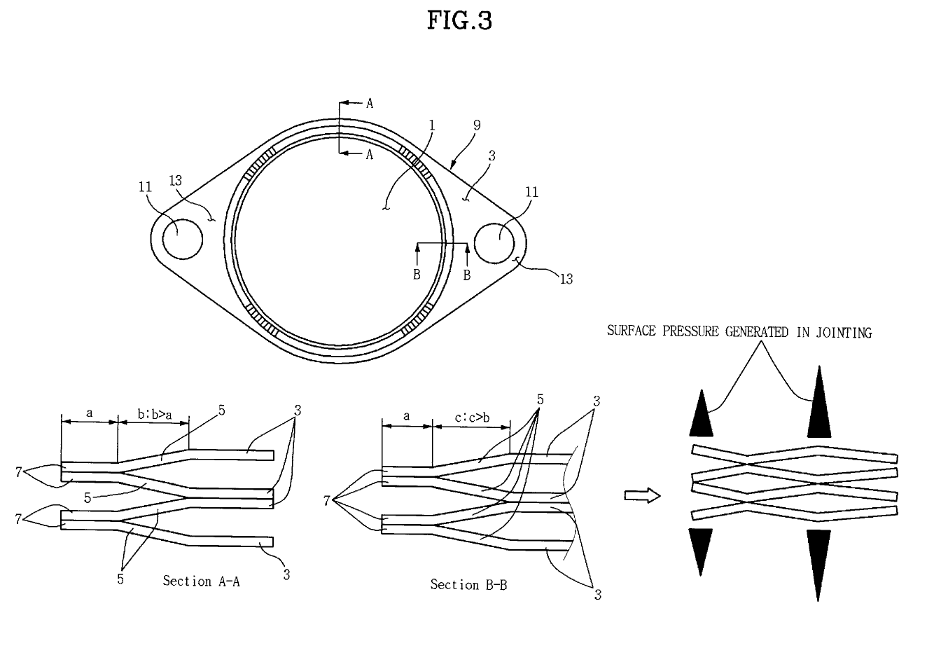

Referring to FIG. 3, according to an exemplary embodiment of the present invention, a gasket for the exhaust gas of a vehicle is formed by overlapping a plurality of plates 2 having a center hole 1. The portion which forms center hole 1 of plate 2 is composed of, in the cross section, bead slope portions 5 bent toward plate portion 3 and bead planes 7 extending from bead slope portion 5 in parallel with plate portion 3 and forming center hole 1, bead planes 7 overlap bead planes 7 of adjacent plates 2 and two adjacent plates 2 have a symmetrical cross section from the portion where bead planes 7 overlap, and bead planes 7 forming center hole 1 all overlap bead planes 7 of adjacent plates 2.

The number of portions where bead planes 7, which form center hole 1, overlap is half the number of plates 2 overlapping to form gasket 9. That is, in this embodiment, the plurality of plates 2 is composed of four plates 3, two adjacent plates 2 of the four plates 2 make a pair with bead slope portions 5 bending to face each other, and bead planes 7 overlap, such that the portion where bead planes 7 overlap is total two.

Plate 2 has connecting portions 13 having a connecting hole 11 at both sides from center hole 1 and the length of bead slope portion 5 is variable with respect to the entire circumference of center hole 1.

That is, as compared by the cross sections taken along the line A-A and the line B-B, the closer the bead slope portion 5 to connecting hole 11 of connecting portion 13 is, the larger the length of the bead slope portion 5 becomes, and the farther the bead slope portion 5 from connecting hole 11 is, the smaller the length becomes.

Changing the length of bead slope portion 5, as described above, is for making the surface pressure generated by gasket 9 uniform around center hole 1, when gasket 9 is pressed between the flanges.

Further, although the length of bead plane 7 is smaller than that of bead slope portion 5, it is larger than the half of the length of bead slope portion 5.

Accordingly, by interposing plates 2 overlapping as described above between the flanges and pressing them to be in close contact with each other, bead planes 7 deform to be spaced apart from each other, such that surface pressure for sealing is generated.

The portions where bead slope portions 5 bend from plates 2 also generate surface pressure for sealing, as shown in the figure.

Therefore, unlike the related art, two ring portions where surface pressure providing double sealing function are formed, such that it is possible to provide stronger sealing performance, and as shown in FIG. 3, uniform and stable surface pressure is generated throughout around center hole 1 and stable sealing function can be provided.

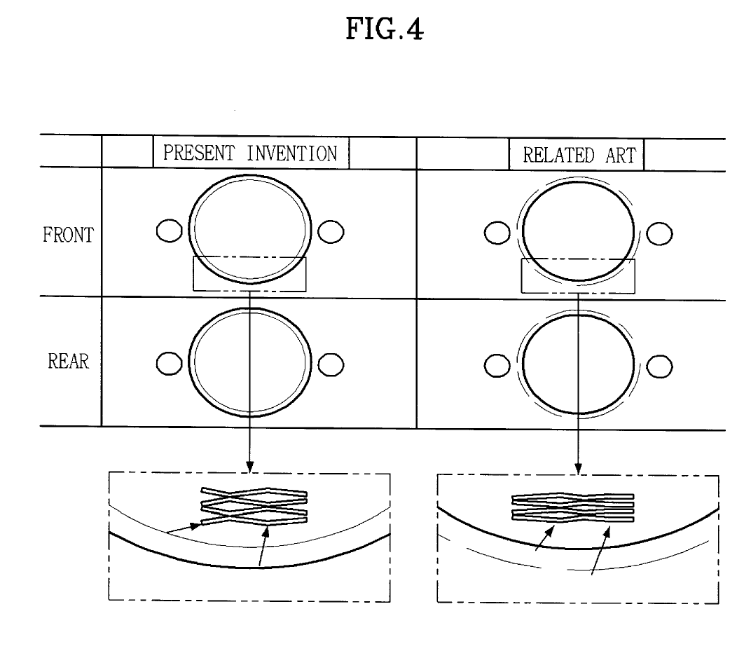

For reference, FIG. 4 compares pressure generated by gasket 9 according to an exemplary embodiment of the present invention and the related art, as a result of measurement using a pressure sensing paper, in which it can be seen that the line colored in the pressure sensing paper used for measuring gasket 9 of the present invention makes a clear double line, as compared with the related art, and the line is entirely uniformly colored without disconnection.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A gasket for an exhaust pipe of a vehicle which is formed by overlapping a plurality of plates having a center hole in common, wherein the plate includes, in the cross section thereof:
a bead plane formed along a circumference of the center hole of the plate;
a bead slope portion extending from the bead plane and bent against a bead slop portion of an adjacent plate; and
a plate portion extending from the bead slope portion outward the center hole,
wherein the bead plane overlaps the bead plane of the adjacent plate.

2. The gasket for the exhaust pipe of the vehicle as defined in claim 1, wherein the plate portion is in parallel with the corresponding bead plane.

3. The gasket for the exhaust pipe of the vehicle as defined in claim 1, wherein two adjacent plates have a symmetrical cross section from the portion where the bead planes of the two adjacent plates overlap.

4. The gasket for the exhaust pipe of the vehicle as defined in claim 1, wherein the total number of portions where the bead planes forming the center hole, overlap each other is half the total number of plate portions of the plates to form the gasket.

5. The gasket for the exhaust pipe of a vehicle as defined in claim 1,
wherein the plate has connecting portions having a connecting hole at both sides of the plate from the center hole, and
wherein the length of the bead slope portion in the plate is variable along the circumference of the center hole.

6. The gasket for the exhaust pipe of a vehicle as defined in claim 5, wherein, the closer the bead slope portion to the connecting hole of the connecting portion is, the larger the length of the bead slope portion from the center hole becomes, and the farther the bead slope portion from the connecting hole is, the smaller the length of the bead slope portion from the center hole becomes.

7. The gasket for the exhaust pipe of a vehicle as defined in claim 6, wherein the length of the bead plane is smaller than the length of the corresponding bead slope portion.

8. The gasket for the exhaust pipe of a vehicle as defined in claim 7, wherein the length of the bead plane is larger than the half of the length of the corresponding bead slope portion.

9. The gasket for the exhaust pipe of a vehicle as defined in claim 7,
wherein the plurality of plates includes even number of plates, and
wherein two adjacent plates make a pair with the bead slope portions bending to face against each other, and the bead planes overlap.
